(19) United States
(12) Patent Application Publication
(10) Pub. No.: US 2002/0163259 A1
(43) Pub. Date: Nov. 7, 2002

(54) DC motor

(75) Inventors: Yoshimi Ohno, Kawasaki-shi (JP); Kenji Koyama, Yokohama-shi (JP); Ikuya Tsurukawa, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: RICOH COMPANY, LTD., Tokyo (JP)

(21) Appl. No.: 09/737,767

(22) Filed: Dec. 18, 2000

(30) Foreign Application Priority Data
Dec. 17, 1999 (JP) 11-360021

(51) Int. Cl. H02K 13/00

(52) U.S. Cl. 310/68 C; 310/233; 310/248

(57) ABSTRACT

A direct current motor, an apparatus including the direct current motor, and method of assembling the direct current motor with the motor including a stator; a rotor with a rotation shaft and rotor coils, a commutator integrally provided with the stator and connected to the rotor coils, a pair of electrode brushes in sliding contact with the commutator and configured to supply electric power from the commutator to the rotor coils to change a state of a direct current drive voltage to the rotor coils, and at least one rotation detecting brush arranged in a direction along an axis of the rotation shaft and in sliding contact with the commutator at a position different from a contact position of at least one of the pair of electrode brushes such that the rotation detecting brush detects a signal on the commutator indicative of an operation of the direct current motor. The pair of electrode brushes may be arranged in contact with the commutator at representative first and second rotation angle positions 180° apart on the commutator and the at least one rotation detecting brush contacts the commutator at a third rotation angle position such that an angle formed between the rotation detecting brush and one of the electrode brushes is less than 180°/n, where n is the number of rotor magnetic poles.

### CROSS-REFERENCE TO RELATED APPLICATIONS

This document claims priority and contains subject matter related to Japanese Patent Application No. 11-360021 filed in the Japanese Patent Office on Dec. 17, 1999 and the entire contents of which are hereby incorporated by reference.

### BACKGROUND OF THE INVENTION

1. Field of the Invention

The present invention relates to a DC (direct current) motor used as a driving force for performing mechanical operations, and more particularly relates to a DC motor wherein rotational operations of a rotor of the DC motor are controlled by detecting at least one of a rotational direction, a rotation speed, a cumulative rotation number and a rotational position of the rotor.

2. Discussion of the Background

A brush-use DC motor is frequently used as a driving force for mechanical operations in a camera, such as for example, zoning operations wherein photographic lenses including a zoom lens are zoomed, focusing operations wherein at least one of a photographic lens and an imaging device is moved along an optic axis of the photographic lens for focusing based on the information of distance from an object to an image focusing point, and film feeding operations wherein a photographic film is wound and rewound.

In the brush-use DC motor, plural fixed magnetic poles are formed in a stator employing a permanent magnet. A DC drive current is switched corresponding to rotation angle of a rotor and is applied to plural rotor coils forming plural magnetic poles of the rotor through a commutator which rotates together with the rotor and through a brush which is in sliding contact with the commutator. Thereby, the rotor rotates.

As another type of the DC motor, a DC brushless motor is used. In the DC brushless motor, a DC drive current is switched by a semiconductor switch, etc. and is applied to stator coils forming plural magnetic poles of a stator. Thereby, a rotor, wherein plural magnetic poles are formed by a permanent magnet, rotates.

There are, for example, five types of apparatuses using a motor as a driving force: (1) unidirectional rotations of the motor are used, and a rotation speed of the motor is required to be kept constant; (2) uni-directional rotations of the motor are used, and a cumulative rotation number of the motor, that is, a total driving amount of the motor is required to be controlled; (3) bi-directional rotations of the motor (i.e., a forward rotation and a reverse rotation) are used, and a rotation speed only on unidirectional rotations of the motor is required to be kept constant; (4) bi-directional rotations of the motor are used, and each rotation speed on bidirectional rotations of the motor is required to be kept constant; and (5) bidirectional rotations of the motor are used, and an accumulated rotational frequency, that is, a total driving amount on uni-directional rotations of the motor is required to be controlled.

With regard to a rotation control method of a motor in an apparatus, there are, for example, two types of apparatuses according to their uses and operation environmental conditions: (1) a rotation speed of the motor is controlled by changing a drive voltage of the motor, and (2) a rotation speed of the motor is controlled by a chopping control wherein a drive voltage is intermittently applied to the motor.

As an example of the above-described brush-use DC motor, FIG. 15 illustrates a three-pole motor. In the three-pole motor, electricity is fed to a commutator CMO which is in sliding contact with a pair of electrode brushes B01 and B02 from a DC drive power supply ED through the paired electrode brushes B01 and B02. The paired electrode brushes B01 and B02 are brought into contact with the commutator CMO on rotation angle positions different by 180°. The commutator CMO includes three pieces which form a cylindrical surface and rotates together with a rotor of the DC motor. The three pieces of the commutator CMO are separated at equally angled interval of about 120°. Three rotor coils are connected to each other between the adjacent pieces of the commutator CMO, and thereby three rotor magnetic poles are formed therebetween. The polarity of these rotor magnetic poles varies depending on the contact state of each piece of the commutator CMO and the electrode brushes B01 and B02 which changes corresponding to the rotation angle of the rotor. Thereby, a rotation driving force is generated between, for example, a pair of stator magnetic poles of a permanent magnet at the side of a stator (not shown).

With the rotation of the rotor, respective rotor magnetic poles oppose respective stator magnetic poles in order, and the contact state of each piece of the commutator CMO and the electrode brushes B01 and B02 changes. Thus, by the variance of the polarity of each rotor magnetic pole in order, the rotor continually rotates.

Specifically, when a voltage is applied to the paired electrode brushes B01 and B02 from the power supply ED, the current flows from one of the electrode brushes B01 and B02 to the other through the rotor coils. The magnetic field is generated by the rotor coils, and thereby the rotor magnetic poles are formed. By the action of the magnetic field generated by the rotor coils and the magnetic field generated by the stator magnetic poles, the rotor rotates.

As a method of detecting the rotation of the above-described motor, a rotary encoder method is known. Specifically, in the rotary encoder method, a rotation slit disk having slits on the circumferential surface thereof is provided on a rotation output shaft of the motor or in a power transmission mechanism rotated by the rotation output shaft. The rotation of the motor is detected by the method of detecting the slits on the circumferential surface of the rotation slit disk with a photointerrupter. Although the rotary encoder method allows an accurate detection of the rotation of the motor, space and cost for the rotary encoder constructed by the rotation slit disk and the photointerrupter are inevitably increased.

Further, another method of detecting the rotation of the motor is by monitoring the drive voltage ripple of the motor, as described referring to FIGS. 16 and 17. In FIG. 16, a resistor R0 is connected in series to electrode brushes B01 and B02 in a power supplying line for supplying the motor drive current to the electrode brushes B01 and B02 from a drive power supply ED, and the voltage between both terminals of the resistor R0 is detected. In such the way, the ripple waveform of a 60° period of the drive current, as illustrated in FIG. 17, is obtained.

Because the ripple waveform corresponds to the rotation angle position of a rotor, the pulse signal corresponding to the rotation angle position can be obtained by suitably rectifying (shaping) the ripple waveform. Although this rotation detecting method is advantageous due to reduced cost and space, detection errors due to noise cause inaccuracies. Thus, this rotation detecting method is disadvantageous.

Japanese Laid-open patent publication No. 4-127864 describes another method for detecting a rotation speed of a DC motor wherein a rotation detecting brush is provided in addition to a pair of electrode brushes. The rotation detecting brush is brought into sliding contact with a commutator to extract a voltage applied to the commutator. The rotation speed of the DC motor is detected based on the signal generated by the rotation detecting brush.

Further, Japanese Utility Model Publication No 6-44294 describes a DC motor wherein a rotation detecting brush is provided in addition to a pair of electrode brushes, and is brought into sliding contact with a commutator of a special shape. Specifically, in order to detect a rotation of the DC motor by the rotation detecting brush, a segment of a special shape is integrally attached to the commutator, and the rotation detecting brush is brought into sliding contact with the segment having a special shape.

In the construction described in Japanese Utility Model Publication No 6-44294, the commutator needs to be produced in a special shape because a segment of a special shape is attached to the commutator. As a result, manufacturing and assembling becomes difficult, so that a manufacturing cost increases. Moreover, because the obtained rotation detecting signal is one rotation period signal, that is, one signal per one rotation of the DC motor, the rotation of the DC motor may not be detected with high accuracy.

Further, Japanese Laid-open patent publication No. 4-127864 and Japanese Utility Model Publication No 6-44294 describe DC motors whose construction prevents mutual contact of the electrode brush with the rotation detecting brush during operation of the DC motor, and prevents mechanical contact of of the electrode brush with the rotation detecting brush during assembly.

### SUMMARY OF THE INVENTION

The present invention has been made in view of the above-discussed and other problems, and an object of the present invention is to address these and other problems.

Accordingly, one object of the present invention is to provide a novel DC motor that detects a rotational operation a DC motor with high accuracy.

Another object of the present invention is to provide a novel DC motor which stably operates electrode brushes and at least one rotation detecting brush without mutual contact, and the motor construction is simple, low-cost, and saves space.

These and other objects are achieved according to the present invention in a novel DC motor, an apparatus including the dc motor, and method of assembling the dc motor with the motor including a stator, a rotor with a rotation shaft and rotor coils, a commutator integrally provided with the stator and connected to the rotor coils, a pair of electrode brushes in sliding contact with the commutator and configured to supply electric power from the commutator to the rotor coils to change a state of a DC drive voltage to the rotor coils, and at least one rotation detecting brush arranged in a direction along an axis of the rotation shaft and in sliding contact with the commutator at a position different from a contact position of at least one of the pair of electrode brushes such that the rotation detecting brush detects a signal on the commutator indicative of an operation of the direct current motor. The pair of electrode brushes may be arranged in contact the commutator at representative first and second rotation angle positions 180° apart on the commutator and the at least one rotation detecting brush contacts the commutator at a third rotation angle position such that an angle formed between the rotation detecting brush and one of the electrode brushes is less than 180°/n, where n is the number of rotor magnetic poles.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic front view of a DC motor of the present invention illustrating a part of the DC motor shown in a longitudinal cross section;

FIG. 2 is a schematic showing an internal cross-sectional view of the DC motor viewing from a left side opposed to a tip end of a rotation shaft of the DC motor;

FIG. 3 is a schematic showing perspective view illustrating a construction of brush contact preventing walls of the present invention;

FIG. 4 is a schematic view illustrating electrode brushes and rotation detecting brushes in the state before being assembled to a support base;

FIG. 5 is a schematic view illustrating the electrode brushes and the rotation detecting brushes in the state of being assembled to the support base;

FIG. 6 is a schematic view illustrating the electrode brushes and the rotation detecting brushes which are moved to a position outside of an outer diameter of a commutator before the support base is assembled to the commutator and the rotation shaft;

FIG. 7 is a schematic view illustrating the support base with the electrode brushes and the rotation detecting brushes which are assembled to the commutator and the rotation shaft;

FIG. 8A is a schematic view illustrating alternative examples of electrode brushes and through-holes;

FIG. 8B is a schematic view illustrating an example of a jig;

FIG. 9 is a circuit diagram illustrating an example of configuration of a rotation detecting device of the DC motor of the present invention;

FIG. 10A is a diagram illustrating waveform of output signal from the rotation detecting brush at the time of high and low speed rotations of the DC motor;

FIG. 10B is a diagram illustrating waveform of output signal from a noise removing circuit at the time of high and low speed rotations of the DC motor;

FIG. 10C is a diagram illustrating waveform of output signal SC1 from the comparator at the time of high and low speed rotations of the DC motor;

FIGS. 11A-11E are schematic views illustrating an example of a DC motor wherein a rotation detecting brush is arranged in a position inclined by 60° relatively to an electrode brush with the commutator rotating clockwise in steps of 30°;

FIG. 12 is a waveform diagram of an output voltage generated from the rotation detecting brush;

FIGS. 13A-13G are schematic views illustrating an example of a DC motor wherein a rotation detecting brush is arranged in a position inclined by 40° relatively to the electrode brush with the commutator rotating clockwise in steps of 20°;

FIG. 14 is a waveform diagram of an output voltage generated from the rotation detecting brush;

FIG. 15 is a schematic circuit diagram employing a three-pole DC motor according to a background art;

FIG. 16 is another schematic circuit diagram employing a three-pole DC motor according to a background art; and

FIG. 17 is a diagram of ripple waveform according to a background art.

### DESCRIPTION OF THE PREFERRED EMBODIMENTS

Embodiments of the present invention are described in detail referring to the drawings, wherein like reference numerals designate identical or corresponding parts throughout the several views.

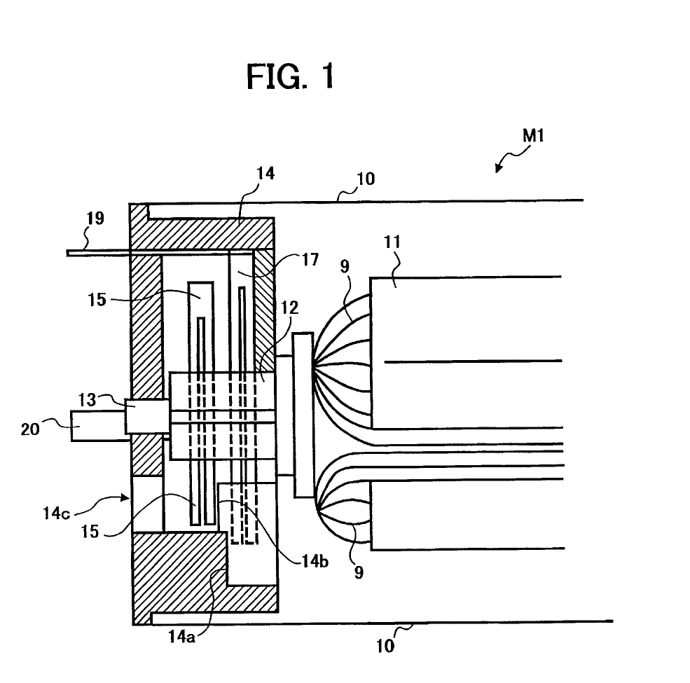

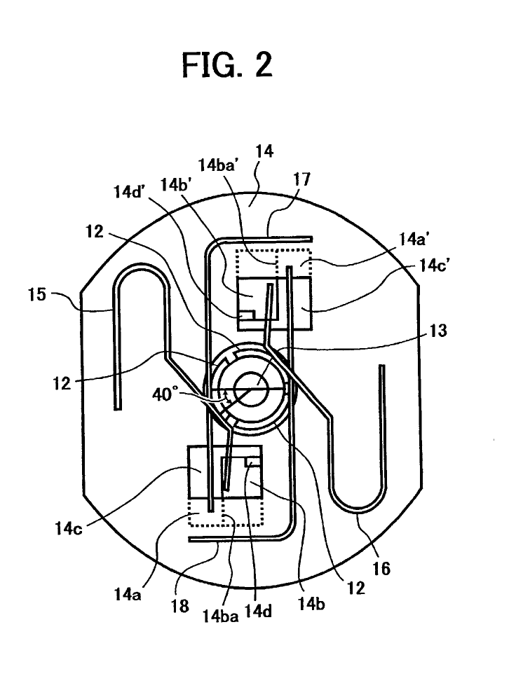

FIGS. 1 and 2 illustrate a construction of a section in the vicinity of electrode brushes and rotation detecting brushes of a DC motor of the present invention. FIG. 1 is a schematic front view of the DC motor which illustrates a part of the DC motor shown in a longitudinal cross section. FIG. 2 is an internal cross-sectional view of the DC motor viewing from the left side opposed to a tip end of a rotation shaft. FIGS. 1 and 2 illustrate main elements of a DC motor M1, i.e., a stator 10, a rotor 11, a commutator 12, a rotation shaft 13, a support base 14, a pair of electrode brushes 15 and 16, a pair of rotation detecting brushes 17 and 18. (The stator 10 and the rotor 11 are not shown in FIG. 2). For sake of clarity, FIG. 1 illustrates only the electrode brush 15 and the rotation detecting brush 17 which are arranged by shifting the position in the thrust direction along an axis of the rotation shaft 13. Referring to FIG. 2, the rotation detecting brushes 17 and 18 are arranged on the rotation angle position of 40° relative to the electrode brushes 15 and 16, respectively.

The rotor 11 forms, for example, three magnetic poles with the structure including three sets of rotor coils 9 wound in the rotor 11. The rotor 11 is fixed on the rotation shaft 13. The commutator 12 includes segments made up of, for example, three conductive pieces which surround the circumference of the rotation shaft 13 at equally angled intervals with a small gap separating each piece. Each set of rotor coils 9 of the rotor 11 is connected to each other between the segments of the commutator 12 adjacent to each other. The rotation shaft 13 rigidly supports the rotor 11 on the intermediate portion of the rotation shaft 13, and fixedly supports the commutator 12 on the portion of the rotation shaft 13 close to one end of the rotor 11. The rotation shaft 13 is rotatably held by the support base 14.

The support base 14 rotatably holds the rotation shaft 13 at a position in the vicinity of one end of the rotation shaft 13 at the side of the commutator 12 by a suitable bearing mechanism. The support base 14 is in the shape of short hollow cylinder which has one end surface portion which accommodates and supports almost all portions of the paired electrode brushes 15 and 16 and the paired rotation detecting brushes 17 and 18 in its hollow portion. When the support base 14 holds the rotation shaft 13, the support base 14 accommodates almost all portions of the commutator 12 in its hollow portion. The detailed structure of the support base 14 is described later.

The stator 10 accommodates the rotor 11, the commutator 12, and the rotation shaft 13. Further the stator 10 partially accommodates the support base 14. In this way, the assembly as mentioned above constitutes a unit of the DC motor M1.

The paired electrode brushes 15 and 16 are shaped as a plate and made of a material which is conductive and resilient. As illustrated in FIG. 2, the electrode brushes 15 and 16 are respectively bent in U shape. One end of each electrode brush 15 and 16 is bent outward. The one end thereof is further bent back such that the tip end portion thereof becomes almost parallel with the non-bent portion. At each other tip end portion of electrode brushes 15 and 16, an extending portion is formed that extends in a direction perpendicular to the end surface portion of the support base 14.

The electrode brushes 15 and 16 are formed in a rotationally symmetrical state relative to the rotation shaft 13 which is almost in parallel with the extending portions. The support base 14 holds the electrode brushes 15 and 16 in the hollow portion such that the electrode brushes 15 and 16 are brought into sliding contact with the commutator 12 on the rotation angle position of 180° relative to the commutator 12.

The paired rotation detecting brushes 17 and 18 are shaped as a plate and made of a material which is conductive and resilient. As illustrated in FIG. 2, the rotation detecting brushes 17 and 18 are respectively bent in an L shape. One portion of each rotation detecting brush 17 and 18 from the bent point is longer than the other portion therefrom. At each tip end portion of the other portions of the rotation detecting brushes 17 and 18, an extending portion that extends in a direction perpendicular to the end surface portion of the support base 14 is formed.

The rotation detecting brushes 17 and 18 are formed in a rotative symmetrical state relative to the rotation shaft 13 which is almost in parallel with the extending portions. The support base 14 holds the rotation detecting brushes 17 and 18 in the hollow portion such that the rotation detecting brushes 17 and 18 are brought into sliding contact with the commutator 12 on a rotation angle position of 180° relative to the commutator 12. In addition, the sliding contact position of each rotation detecting brush 17 and 18 is at a position different from the sliding contact position of each electrode brush 15 and 16 and is at a predetermined positional interval in the thrust direction along the axis of the rotation shaft 13. The sliding contact positions of the rotation detecting brushes 17 and 18 are shifted by a predetermined rotation angle, for example, 40° relative to the sliding contact positions of the electrode brushes 15 and 16, respectively.

The support base 14 includes a through-hole on the center of the end plate portion thereof so as to pass the rotation shaft 13 into the through-hole and to rotatably hold the rotation shaft 13. A bearing portion is formed at the through-hole.

On the inside of the support base 14, brush contact preventing walls 14a and 14b are provided. The brush contact preventing wall 14a prevents the rotation detecting brush 17 from neighboring to the electrode brush 15. The brush contact preventing wall 14b prevents the electrode brush 15 from being proximate to the rotation detecting brush 17. Both brush contact preventing walls 14a and 14b constitute a brush contact preventing member.

On the end surface portion of the support base 14, a through-hole 14c is formed at a position where the tip end of the electrode brush 15, the brush contact preventing wall 14b, and the part in the vicinity of the tip end of the rotation detecting brush 17 are located.

Further, on the inside of the support base 14, brush contact preventing walls 14a′ and 14b′ are provided. The brush contact preventing wall 14a′ prevents the rotation detecting brush 18 from being proximate to the electrode brush 16. The brush contact preventing wall 14b′ prevents the electrode brush 16 from being proximate to the rotation detecting brush 18.

Both-brush-contact preventing walls 14a′ and 14b′ also constitute a brush-contact-preventing member.

On the end surface portion of the support base 14, a through-hole 14c′ is formed on a position where the tip end of the electrode brush 16, the brush contact preventing wall 14b′, and the part in the vicinity of the tip end of the rotation detecting brush 18 are located. In FIG. 1, the through-hole 14c′, the brush contact preventing walls 14a′ and 14b′ are omitted for clarity of illustration.

Respective tip ends of one extending portion of the electrode brushes 15 and 16, and respective tip ends of one extending portion of the rotation detection brushes 17 and 18 protrude outward from the end surface portion of the support base 14 to serve as external terminals 20 and 19 for connection, respectively.

As described later, the through-holes 14c and 14c′ are used as a jig insertion port through which a jig as a contact preventing member is installed and put therein so as to prevent the mutual contact of the electrode brushes 15 and 16, the mutual contact of the rotation detecting brushes 17 and 18, and the contact of brushes 15 through 18 with the commutator 12 at the time of assembling.

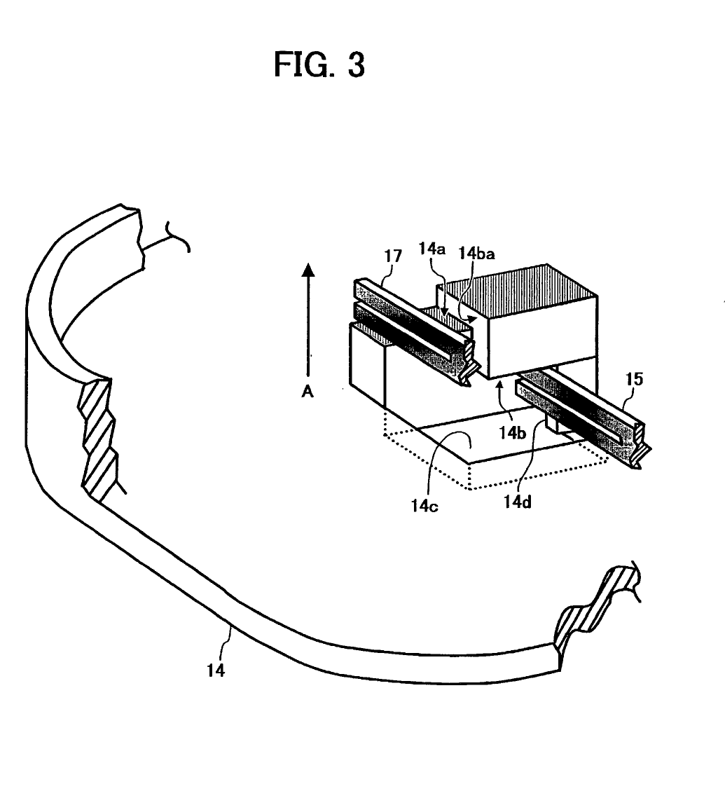

FIG. 3 is a schematic perspective view illustrating a construction of the brushcontact-preventing walls 14a and 14b. In FIG. 3, the axial direction of the rotation shaft 13 is indicated by arrow A. As illustrated in FIG. 3, the brush-contact-preventing wall 14a prevents the rotation detecting brush 17 from moving toward the electrode brush 15 in the axial direction of the rotation shaft 13, and the brush contact preventing wall 14b prevents the electrode brush 15 from moving toward the rotation detecting brush 17 in the axial direction of the rotation shaft 13.

Further, the rotation detecting brush 17 is prevented from moving toward the electrode brush 15 in the direction perpendicular to the axis of the rotation shaft 13 by a brush-contact-preventing wall 14ba.

As illustrated in FIG. 3, the through-hole 14c is formed in the end surface portion of the support base 14 at a position where the tip end of the electrode brush 15 situated at the or front of the brush contact preventing wall 14b is located at the front side (i.e., close to the hole 14c) and where the portion in the vicinity of the tip end of the rotation detecting brush 17 is located at the rear side (i.e., apart from the hole 14c).

Owing to the above-described construction of the DC motor M1, the brush-contact-preventing walls 14b and 14b′ prevent the electrode brushes 15 and 16 from moving toward the rotation detecting brushes 17 and 18 in the axial direction of the rotation shaft 13, respectively. The brush-contact-preventing walls 14a and 14a′ prevent the rotation detecting brushes 17 and 18 from moving toward the electrode brushes 15 and 16 in the axial direction of the rotation shaft 13, respectively. The brush-contact-preventing walls 14ba and 14ba′ prevent the rotation detecting brushes 17 and 18 from moving toward the electrode brushes 15 and 16 in the direction perpendicular to the axis of the rotation shaft 13. Even when slight deformation of the brushes 15 through 18 occurs at the time of assembling and when a slight deviation occurs during operation of the DC motor M1, mutual contact of the electrode brushes 15 and 16 with the rotation detection brushes 17 and 18 does not occur. Therefore, the reliability of the rotation detecting signal and the motor operation is ensured.

As illustrated in FIGS. 1 through 3, the paired electrode brushes 15 and 16 and the paired rotation detecting brushes 17 and 18 contact the commutator 12 such that the respective pairs are arranged apart in the thrust direction along the axis of the rotation shaft 13. Therefore, there is no mutual contact of the paired electrode brushes 15 and 16 and the paired rotation detecting brushes 17 and 18 at the time of transportation and operations, etc. of the DC motor. As a result, malfunctions and troubles, etc. of the DC motor can be effectively prevented.

Moreover, as described above, because the paired electrode brushes 15 and 16 and the paired rotation detecting brushes 17 and 18 are arranged at a position shifted in the thrust direction along the axis of the rotation shaft 13 relative to the commutator 12, there are margins in setting the shape of the brushes 15 through 18 and the angles therebetween.

As described above, the electrode brushes 15 and 16 and the rotation detecting brushes 17 and 18 are fixed on the hollow portion of the support base 14 which rotatably holds the rotation shaft 13 of the DC motor M1. Further, the external terminals 19 of the rotation detecting brushes 17 and 18, and the external terminals 20 of the electrode brushes 15 and 16 are integrally mounted on the support base 14 such that tip end portions thereof protrude outward from the end surface portion of the support base 14. Owing to the above-described simple and space saving construction of the DC motor M1, the cost and size of the DC motor is reduced.

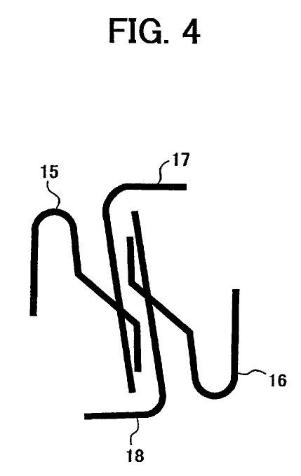

Next, the method of assembling the parts of the above-described DC motor related to the electrode brushes 15 and 16 and the rotation detecting brushes 17 and 18 is described referring to FIGS. 4 through 7.

FIG. 4 illustrates the electrode brushes 15 and 16, and the rotation detection brushes 17 and 18 in the state before being assembled to the support base 14. As illustrated in FIG. 4, each brush 15 through 18 is formed in a shape which is deflected in a predetermined direction so as to press to the outer circumferential surface of the commutator 12 when each brush 15 through 18 is assembled to the support base 14.

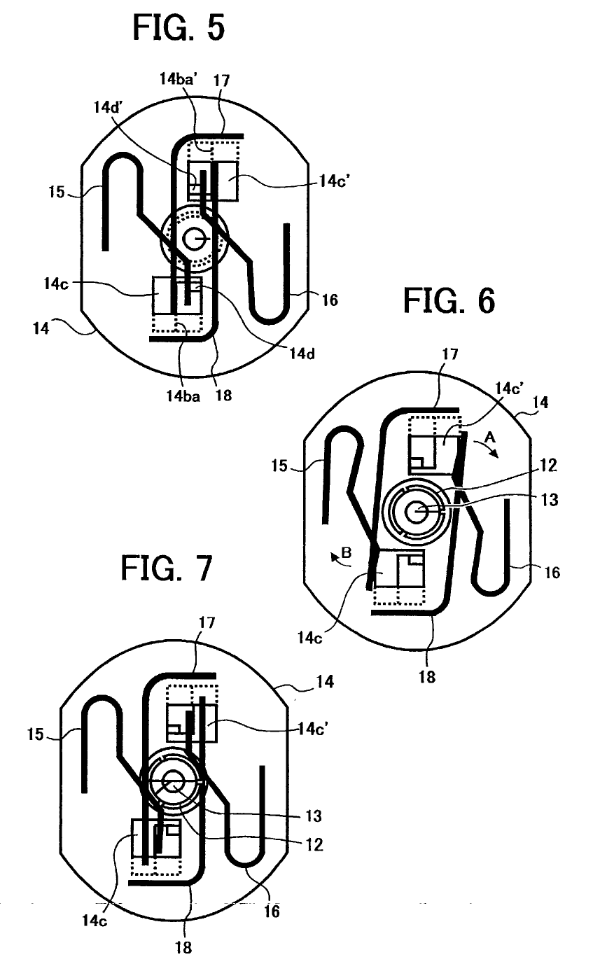

FIG. 5 illustrates the electrode brushes 15 and 16 and the rotation detecting brushes 17 and 18 upon assembly to the support base 14. Referring to FIG. 5, the brushes 15 through 18 are temporarily fixed on the support base 14 such that the electrode brushes 15 and 16 respectively abut stoppers 14d and 14d′, and the rotation detecting brushes 17 and 18 abut the brush contact preventing walls 14ba and 14ba′, respectively. Because the electrode brushes 15 and 16 are respectively stopped by the stoppers 14d and 14d′ and the rotation detecting brushes 17 and 18 are respectively stopped by the brush-contact-preventing walls 14ba and 14ba′, a jig (described later) can be smoothly inserted in each through-hole 14c and 14c′.

The stoppers 14d and 14d′ may be permanently provided, or may be provided temporarily and then detached. The brush-contact-preventing walls 14ba and 14ba′ respectively construct side walls of the brush-contact-preventing walls 14b and 14b′. (FIG. 33 illustrates the stopper 14d and the brush-contact-preventing walls 14b and 14ba.)

FIG. 6 illustrates that the electrode brushes 15 and 16 and the rotation detecting brushes 17 and 18 are moved to the position outside of the outer diameter of the commutator 12 before the support base 14 is assembled to the commutator 12 and the rotation shaft 13. In order to move the brushes 15 through 18 to the position outside of the outer diameter of the commutator 12 for making a space for the commutator 12, a jig (not shown) is inserted into the holes 14c and 14c′ and pushes the brushes 15 through 18 outward against spring force of the brushes 15 through 18. The moving direction of the electrode brush 16 and the rotation detecting brush 18 is indicated by arrow A, and the moving direction of the electrode brush and the rotation detecting brush 17 is indicated by arrow B in FIG. 6. Then, the brushes 15 through 18 are stopped by connecting the jig to the brushes, and thereby a space for the commutator 12 and the rotation shaft 13 is formed in the support base 14 as illustrated in FIG. 6.

The jig has an outer shape corresponding to the through-holes 14c and 14c′, and also has an outer shape at the tip end portion of the jig capable of easily pushing the brushes 15-18 outward when the jig is inserted in the through-holes 14c and 14c′.

Upon inserting the jig, as illustrated in FIG. 6, the electrode brushes 15 and 16 and the rotation detecting brushes 17 and 18 are moved to the position outside of the outer diameter of the commutator 12 and are stopped by the jig. Therefore, the brushes 15 through 18 do not return to the original position while the jig is inserted. In the above-described state of the brushes 15-18 illustrated in FIG. 6, the brushes 15-18 are held while the commutator 12 and rotation shaft 13 are assembled onto the support base 14.

FIG. 7 illustrates the support base 14 with the brushes 15-18 assembled to the commutator 12 and rotation shaft 13. After the support base 14 is assembled to the commutator 12 and rotation shaft 13, the jig is removed from the through-holes 14c and 14c′, and the brushes 15-18 are brought into contact with the commutator 12 due to a resiliency restoring force in the brushes 15-18.

As described above, the electrode brushes 15 and 16, and the rotation detecting brushes 17 and 18 are assembled into the support base 14, and then the support base 14 is assembled to the commutator 12 and rotation shaft 13, and further necessary parts are assembled. Thus, assembling of the DC motor M1 is completed.

In order to obtain the stable motor operation and the rotation detecting signal, each brush 15-18 requires an appropriate contact pressure with the commutator 12. If the support base 14 is assembled to the commutator 12 in the condition that each brush 15-18 is free or temporarily fixed on the support base 14 as illustrated in FIGS. 4 and 5, each brush 15-18 is forcibly opened against the spring restoring force thereof in each brush.

Thus, because the support base 14 is assembled to the commutator 12 after each brush 15-18 is moved to the position outside of the outer diameter of the commutator 12 by the jig, deformation of the brushes 15-18 due to contact with the commutator 12 during assembly does not occur. Therefore, the reliability of the rotation detecting signal and the motor operation can be ensured. Further, because workability in assembling the DC motor is increased, mass-productivity of the DC motor is improved.

In the above-described DC motor M1, the jig for moving the brushes 15 through 18 to the position outside of the outer diameter of the commutator 12 is inserted into the through-holes 14c and 14c′ only at the time of assembling. Alternatively, a stop member may be provided in the support base 14, which can be easily operated from outside the support base to move and return the brushes 15-18.

Further, in the above-described construction of the DC motor M1, the paired rotation detecting brushes 17 and 18 are arranged at the side close to the rotor 11, and the paired electrode brushes 15 and 16 are arranged at the side close to the external terminals 19 and 20. Alternatively, the positions of the paired electrode brushes 15 and 16 and the paired rotation detection brushes 17 and 18 in the axial direction of the rotation shaft 13 may be opposite.

Although the pair of rotation detecting brushes 17 and 18 is provided in the DC motor M1, only one of the rotation detecting brushes 17 and 18 may be provided.

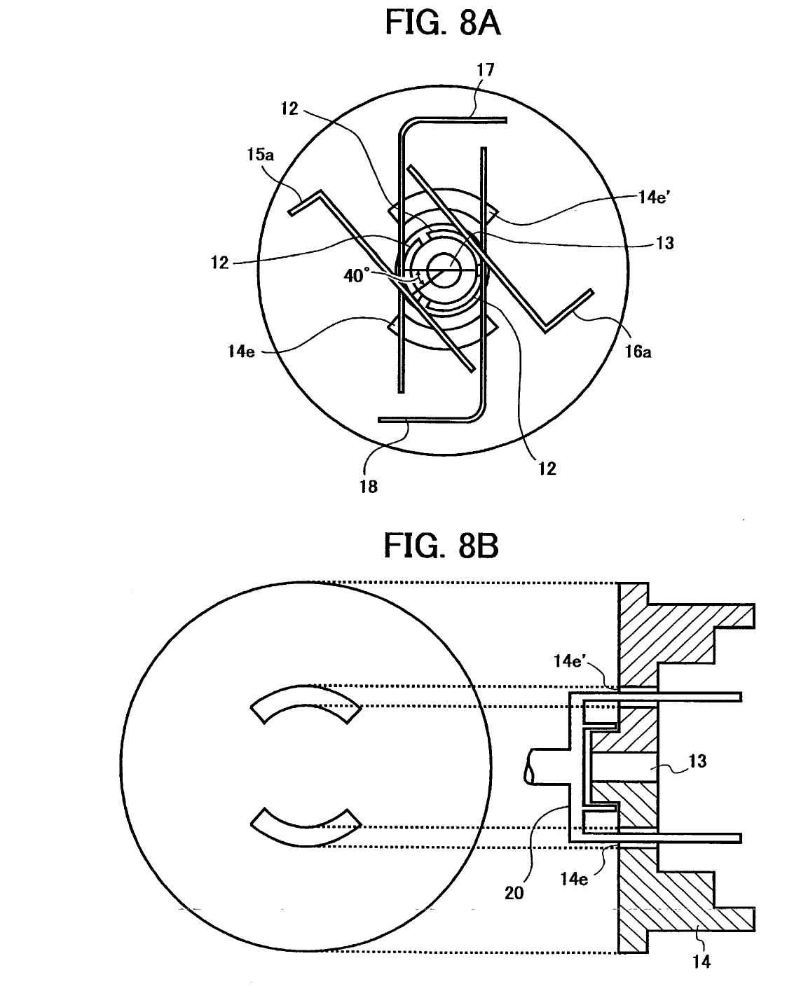

As illustrated in FIG. 8A, as alternatives to the electrode brushes 15 and 16, electrode brushes 15a and 16a of similar L shape as the rotation detecting brushes 17 and 18 may be used. Further, as alternatives to the through-holes 14c and 14c′, through-holes 14e and 14c′ in a shape of a partially-round slit may be provided. An example of a jig 20 that is inserted in the through-holes 14e and 14e′ is schematically illustrated in FIG. 8B. The jig 20 is turned along the partially-round slit of the through-holes 14e and 14e′ to move the brushes 15a, 16a, 17, and 18 to a position outside of the outer diameter of the commutator 12.

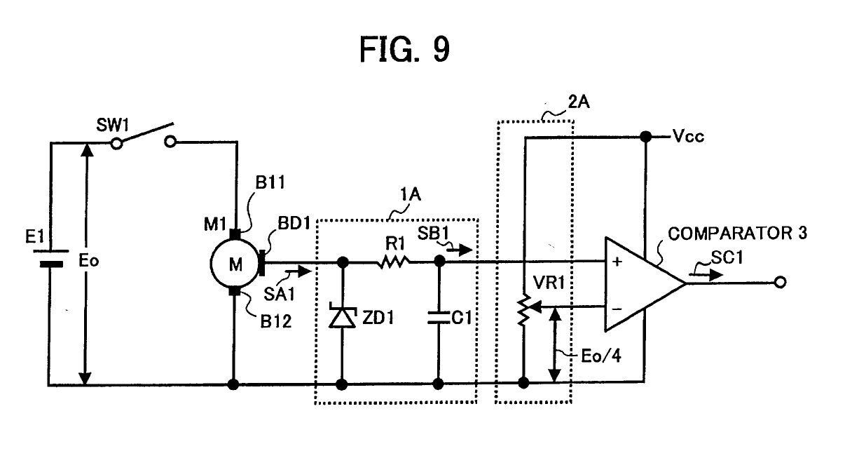

FIG. 9 is a circuit diagram illustrating an example of a configuration of a rotation detecting device that detects the operation of the above-described DC motor M1. The DC motor M1 is driven by being applied with a drive voltage Eo from a drive power supply E1 through a switch SW1. The DC motor M1 includes one rotation detecting brush BD1 in addition to a pair of electrode brushes B11 and B12.

The rotation detecting device includes a noise removing circuit 1, a reference voltage generating device 2, and a comparator 3. The noise removing circuit 1 removes noise components such as the waveform in a state of a sharp surge from the signal detected by the rotation detecting brush BD1 and applies the detecting signal voltage to the comparator 3. The noise removing circuit 1 includes a constant-voltage diode ZD1, a resistor R1, and a capacitor C1.

The constant-voltage diode ZD1 (e.g., zener diode, etc.) is connected across the rotation detecting brush BD1 and the common low-voltage side of the drive power supply E1 The common low-voltage side of the drive power supply E1 may be referred to as a ground level.

The resistor R1 and the capacitor C1 are connected in series. One side of the resistor R1 is connected to the rotation detecting brush BD1, and the capacitor C1 is connected to the common low-voltage side of the drive power supply E1. The series circuit of the resistor R1 and the capacitor C1 is connected in parallel with the constant voltage diode ZD1 across the rotation detecting brush BD1 and the common low-voltage side of the drive power supply E1.

A voltage between both terminals of the capacitor C1, that is, a voltage between a connection point of the capacitor C1 and the resistor R1 and the common low-voltage side of the drive power supply E1, is applied to a non-inversion input terminal (i.e., +side) of the comparator 3.

The reference voltage generating device 2 generates a reference voltage for converting the detection signal generated by the rotation detecting brush BD1 into pulse train of pulse period and pulse width corresponding to the rotation speed of the DC motor M1, and then applies the reference voltage to the comparator 3. The reference voltage generating device 2 includes a potentiometer VR1. Both terminals at both fixed sides of the potentiometer VR1 are connected to a power supply voltage Vcc side and the common low-voltage side, respectively. A voltage between the movable terminal of the potentiometer VR1 and the common low-voltage side (e.g., a reference voltage almost equal to Eo/4) is applied to an inversion input terminal (i.e., the negative side) of the comparator 3.

In the comparator 3, the voltage of the detection signal generated by the rotation detecting brush BD1 from which the noise is removed by the noise removing circuit 1 is applied to the non-inversion input terminal (i.e., the positive side), and the reference voltage (Eo/4) generated by the reference voltage generating device 2 is applied to the inversion input terminal (i.e., −the negative side). The comparator 3 compares a voltage of the above-described detection signal with the reference voltage (Eo/4).

When an output voltage from the noise removing circuit 1 exceeds the reference voltage (Eo/4), the comparator 3 outputs the power supply voltage Vcc (i.e., a high or first level), and when the output voltage from the noise removing circuit 1 equals to the reference voltage (Eo/4) or smaller, the comparator 3 outputs the common low-voltage (i.e., a low or second level). The comparator 3 outputs pulse train of pulse period and pulse width corresponding to the rotation speed of the DC motor M1.

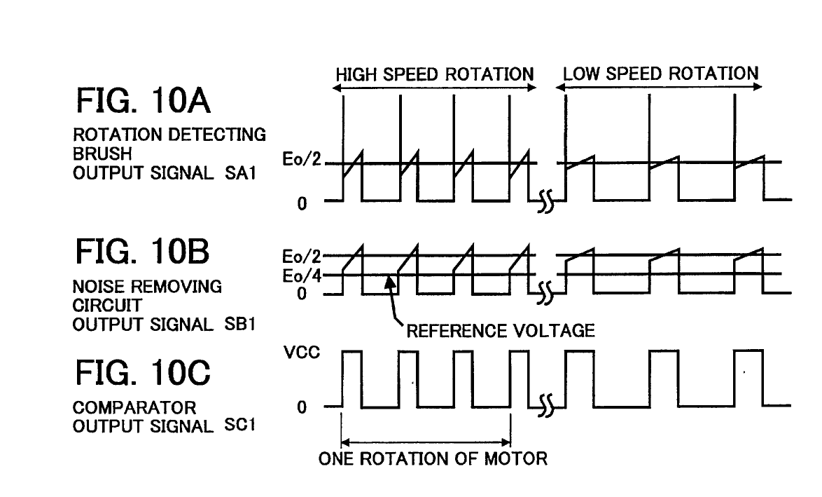

Next, an operation of the rotation detecting device of the DC motor M1 of FIG. 9 is described referring to FIGS. 10A through 10C. FIG. 10A is a diagram illustrating waveform of output signal SA1 from the rotation detecting brush BD1 at the time of high and low speed rotations of the DC motor M1. FIG. 10B is a diagram illustrating waveform of output signal SB1 from the noise removing circuit 1 at the time of high and low speed rotations of the DC motor M1. FIG. 10C is a diagram illustrating waveform of output signal SC1 from the comparator 3 at the time of high and low speed rotations of the DC motor M1.

The DC motor M1 and the switch SW1 are connected in series to the drive power supply E1 with a drive voltage Eo. The rotation detecting brush BD1 of the DC motor M1 is connected to the noise removing circuit 1. As described above, in the noise removing circuit 1, the series circuit of the resistor R1 and the capacitor C1 is connected in parallel with the constant-voltage diode ZD1. The constant-voltage diode ZD1 clamps the voltage of the counter electromotive force induced by the action of self-induction of the rotor windings of the DC motor M1, i.e., the rotor coils 9.

The resistor R1 and the capacitor C1 construct a lowpass filter for extracting an output voltage from a connection point of the resistor R1 and the capacitor C1 which removes high frequency components. The output voltage extracted from the connection point of the resistor R1 and the capacitor C1 is applied to the non-inversion input terminal (i.e., the positive side) of the comparator 3.

When the switch SW1 is closed, the drive voltage Eo is applied to the DC motor M1 from the drive power supply E1. Thereby, the rotor coils 9 are magnetically excited through the electrode brushes B11 and B12, and the rotor 11 rotates relative to the permanent magnets in the stator 10. By the rotation of the DC motor M1, the voltage signal SA1, almost in the state of pulse, is generated onto the rotation detecting brush BD1.

Regarding the sharp surge-state waveform of the leading edge portion of each pulse in the pulse train of the voltage signal SA1 (illustrated in FIG. 10A) output from the rotation detecting brush BD1, because the magnitude of the current flowing through the rotor coils 9 connected to respective conductive pieces of the commutator 12 instantaneously varies when the conductive pieces of the commutator 12 in contact with the rotation detecting brush BD1 are changed over, the above-described variation of the current is caused by the voltage generated by the action of the self-induction of the rotor coils 9. The peak value and width of the surge voltage waveform vary in accordance with the magnitude of the current flowing through the rotor coils 9 corresponding to the rotation speed of the DC motor M1.

The inclined portion of each pulse is composed of superposing the voltage generated by current flowing through the rotor coils 9 due to the DC resistive components of the rotor coils 9 with the voltage induced by the action of the rotor coils' rotation in the magnetic field. The latter induction voltage turns out to be dominant at the time of the high speed rotation of the DC motor M1, and the former voltage generated by the current flowing through the rotor coils 9 and by the DC resistance components of the rotor coils 9 turns out to be dominant at the time of the low speed rotation of the DC motor M1. Therefore, as illustrated in FIGS. 10A and 10B, the lower the speed of rotation becomes, the smaller the inclination angle of each pulse becomes.

In the waveform of the output signal SB1 from the noise removing circuit 1, as illustrated in FIG. 10B, the above-described surge waveform and high-frequency noise such as mechanical noise, etc., caused by the contact of the rotation detecting brush BD1 with the commutator 12 are removed. The comparator 3 compares a voltage of the output signal SB1 from the noise removing circuit 1 with the reference voltage (e.g., about Eo/4) taken from the potentiometer VR1.

Referring to FIG. 10C, the output signal SC1 from the comparator 3 is alternately only one of two voltage levels, i.e., the power supply voltage Vcc (high level) and the common low-voltage (low level). Consequently, a stable rectangular waveform is obtained.

The noise removing circuit 1 is suitably constructed according to the properties of the specific DC motor used e.g., the electric power consumed by the DC motor, and the voltage of a signal processing circuit system. Further, the noise removing circuit 1 may be a dispensable structure. Depending on the property of the used DC motor, the electric power consumed by the DC motor, and the voltage of the signal processing circuit system, etc., the noise removing circuit 1 may not be needed.

Next, an arrangement of a rotation detecting brush of a DC motor of the present invention is described.

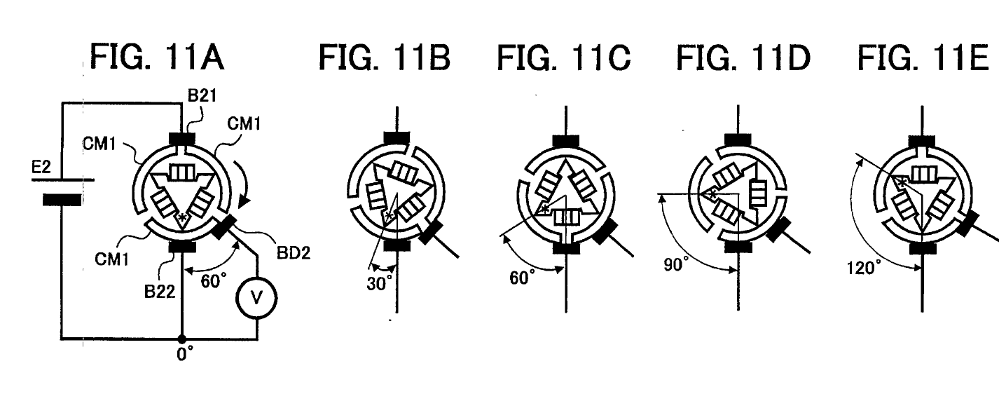

FIGS. 11A through 11E illustrate an example of a DC motor wherein a rotation detecting brush BD2 is arranged in a position inclined by 60° relatively to one of electrode brushes B21 and B22, e.g., the electrode brush B22 in FIGS. 11A through 11E. Accordingly, an angle between the electrode brush B21 and the rotation detecting brush BD2 is larger than an angle between the electrode brush B22 and the rotation detecting brush BD2.

FIG. 11A illustrates an initial state of commutator CM1 of the DC motor. FIGS. 11B through 11E respectively illustrate the states of the commutator CM1 rotating clockwise in order by 30°.

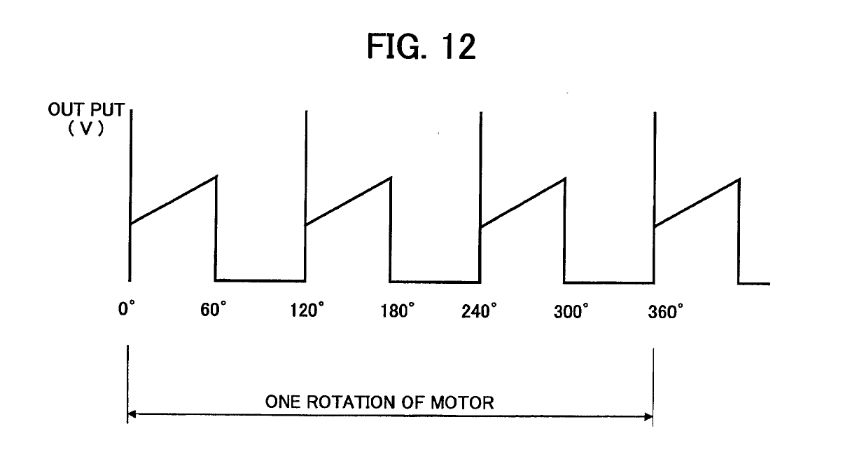

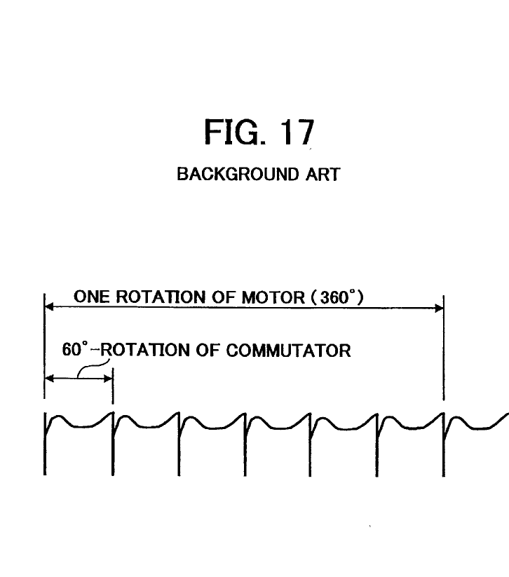

FIG. 12 illustrates an estimated voltage waveform of an output voltage V generated from the rotation detecting brush BD2 when the commutator CM1 and the rotor are rotated as illustrated in FIGS. 11A through 11E. As is apparent from a comparison with the waveform at the time of detecting rotation's number of the motor from the drive voltage ripple of the motor illustrated in FIG. 17, the waveform of the output voltage V in FIG. 12 largely varies per 60°.

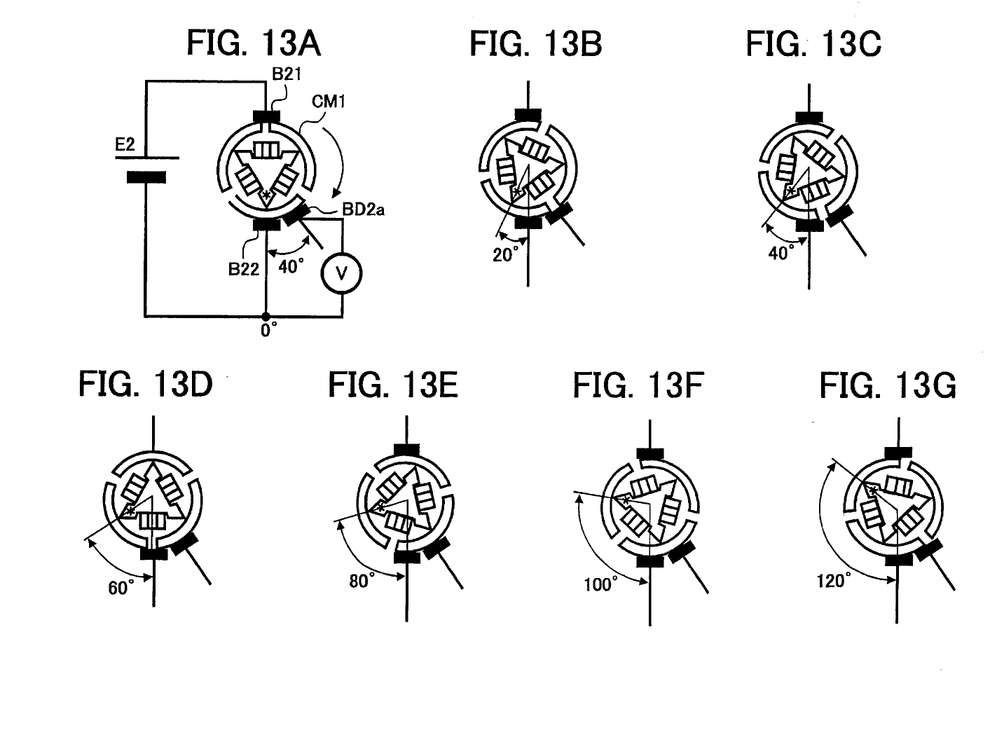

FIGS. 13A through 13G illustrate another example of the DC motor wherein a rotation detecting brush BD2a is arranged in a position inclined by 40° relatively to one of the electrode brushes B21 and B22, e.g., the electrode brush B22 in FIGS. 13A-13G. FIG. 13A illustrates an initial state of the commutator M1 of the DC motor. FIGS. 13B through 13G respectively illustrate the states of the commutator CM1 rotating clockwise in order by 20°.

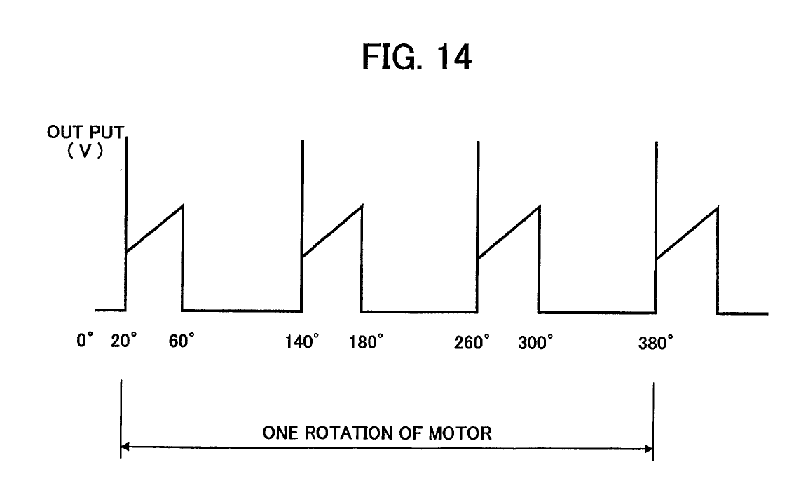

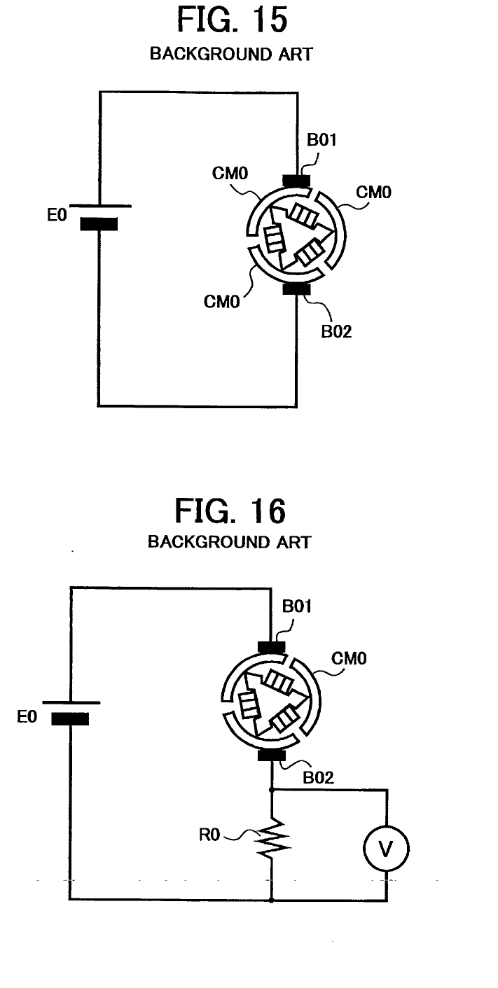

FIG. 14 illustrates an estimated voltage waveform of an output voltage V generated from the rotation detecting brush BD2a when the commutator CM1 and the rotor are rotated as illustrated in FIGS. 13A through 13G. If the voltage waveform is the one as illustrated in FIG. 12 or FIG. 14, the information relating to the number of rotations of the DC motor can be detected from the waveform of output signal SB1 from which the high-frequency component, such as, the ripple, etc. is removed from the output voltage V by causing the output voltage V to pass through the lowpass filter.

Referring to FIG. 11A, the electrode brush B21 which is connected to the positive (+) side of a power supply E2 contacts a right upper segment of the commutator CM1, and is connected to a lower segment of the commutator CM1 through the rotation detecting brush BD2. Thereby, the electrode brush B21 is connected to the electrode brush B22 which is connected to the negative (−) side of the power supply E2.

In the above-described connecting condition of the electrode brushes B2 1 and B22 and the rotation detecting brush BD2, both terminals of the DC power supply E2 can be short-circuited. Although no serious problem occurs when the DC motor rotates in a high speed, serious problem occurs when the DC motor stops rotating in the short-circuited state of the power supply E2.

Generally, coils are wound around an iron core of a rotor of a DC motor. When no current flows through the coils, the iron core of the rotor is attracted to a magnetic pole of a stator employing a permanent magnet. In a case of a three-pole DC motor, for example, stable points created by the attraction force exist on 6 positions per one rotation of the rotor. If the rotation detecting brush BD2 is brought into contact with the commutator CM1 at a position different from the position corresponding to the above-described stable points; the above-described short-circuiting condition problem may be eliminated. However, basically, it is preferable to construct the DC motor as illustrated in FIGS. 13A through 13G so as to avoid the short-circuited state of the power supply E2.

Regarding the arrangement of the rotation detecting brush BD2a in the non short-circuited state of the power supply E2, the angle formed between the rotation detecting brush BD2a and one of the electrode brushes B21 and B22 located at near side of the rotation detecting brush BD2a is less than 60° in the case of three-pole DC motor. In the case of n-pole DC motor, the angle is less than (180°/n).

As a result, by setting the contact position of the rotation detecting brush BD2a with the commutator CM1 to the above-described rotation angle position, the reliability of the rotation detecting signal and the motor operation can be improved.

Numerous additional modifications and variations of the present invention are possible in light of the above teachings. It is therefore to be understood that within the scope of the appended claims, the present invention may be practiced otherwise than as specifically described herein.

What is claimed as new and desired to be secured by Letters Patents of the United States is:

1. A direct current motor comprising:
a stator;
a rotor including,
a rotation shaft, and rotor coils;
a commutator integrally provided with the stator and connected to the rotor coils;
a pair of electrode brushes in sliding contact with the commutator and configured to supply electric power from the commutator to the rotor coils to change a state of a direct current drive voltage to the rotor coils; and
at least one rotation detecting brush in sliding contact with the commutator and arranged at a position in a direction along an axis of the rotation shaft different from contact positions of the pair of electrode brushes, said at least one rotation detecting brush configured to detect a signal on the commutator indicative of an operation of the direct current motor.

2. The direct current motor according to claim 1, further comprising:
external terminals for the electrode brushes;
at least one external terminal of the at least one rotation detecting brush; and
a support base configured to rotatably hold the rotation shaft of the rotor,
wherein the electrode brushes, the at least one rotation detecting brush, the external terminals for the electrode brushes, and the at least one external terminal of the at least one rotation detecting brush are fixed on the support base and the external terminals for the electrode brushes and the at least one external terminal of the at least one rotation detecting brush are configured to connect outside said direct current motor.

3. The direct current motor according to claim 2, further comprising:
through holes in the support base,
whereby a jig may be inserted in said through holes to prevent contact of the electrode brushes and the at least one rotation detecting brush with the commutator during assembly of the commutator onto the support base.

4. The direct current motor according to claim 3, wherein the electrode brushes and the at least one rotation detecting brush have shapes configured to provide resilient tension against the commutator.

5. The direct current motor according to claim 4, wherein a first of at least one of the electrode brushes and the at least one rotation detecting brush has an L shape configuration and a second of at least one of the electrode brushes and the at least one rotation detecting brush has an U shape configuration.

6. The direct current motor according to claim 5, wherein the L shape configuration contacts the commutator with along an extended side of the L shape configuration.

7. The direct current motor according to claim 5, wherein the U shape configuration contacts the commutator on a straight length offset portion of the U shape configuration.

8. The direct current motor according to claim 2, further comprising:
a first brush-contact-preventing wall provided in the support base is configured to prevent the at least one rotation detecting brush from being proximate to at least one of the electrode brushes; and
a second brush-contact-preventing wall provided in the support base is configured to prevent the at least one of the electrode brushes from being proximate to the at least one rotation detecting brush.

9. The direct current motor according to claim 1, further comprising:
a rotation detecting device connected to the at least one rotation detecting brush and configured to detect the signal on the commutator.

10. The direct current motor according to claim 9, wherein said at least one rotation detecting device is configured to detect at least one of a rotational speed, a cumulative rotation number, and a rotational direction of the direct current motor.

11. The direct current motor according to claim 10, wherein the rotation detecting device comprises:
a noise removing circuit configured to remove high frequency noise components from the signal on the commutator;
a reference voltage generating device configured to convert the signal on the commutator and to output a converted voltage; and
a comparator configured to compare the converted voltage to a reference voltage and output a first level voltage when the converted voltage is at least the reference voltage and output a second level voltage different from said first level voltage when the converted voltage is less than the reference voltage, output from said comparator having a peak height and peak width.

12. The direct current motor according to claim 11, wherein the peak width of the said output from said comparator varies in accordance with the rotation speed of the direct current motor.

13. The direct current motor according to claim 1, wherein the pair of electrode brushes is configured to contact the commutator at representative first and second rotation angle positions 180° apart on the commutator and the at least one rotation detecting brush is configured to contact the commutator at a third rotation angle position such that an angle formed between the at least one rotation detecting brush and one of the electrode brushes is less than 180°/n, where n is the number of rotor magnetic poles.

14. An apparatus having a direct current motor comprising:
a stator;
a rotor including,
a rotation shaft, and rotor coils;
a commutator integrally provided with the stator and connected to the rotor coils;
a pair of electrode brushes in sliding contact with the commutator and configured to supply electric power from the commutator to the rotor coils to change a state of a direct current drive voltage to the rotor coils; and
at least one rotation detecting brush in sliding contact with the commutator and arranged at a position in a direction along an axis of the rotation shaft different from contact positions of the pair of electrode brushes, said at least one rotation detecting brush configured to detect a signal on the commutator indicative of an operation of the direct current motor.

15. The apparatus according to claim 14, wherein said direct current motor further comprises:
external terminals for the electrode brushes;
at least one external terminal of the at least one rotation detecting brush; and
a support base configured to rotatably hold the rotation shaft of the rotor,
wherein the electrode brushes, the at least one rotation detecting brush, the external terminals for the electrode brushes, and the at least one external terminal of the at least one rotation detecting brush are fixed on the support base and the external terminals for the electrode brushes and the at least one external terminal of the at least one rotation detecting brush are configured to connect outside said direct current motor.

16. The apparatus according to claim 15, wherein said direct current motor further comprises:
through holes in the support base,
whereby a jig may be inserted in said through holes to prevent contact of the electrode brushes and the at least one rotation detecting brush with the commutator during assembly of the commutator onto the support base.

17. The apparatus according to claim 16, wherein the electrode brushes and the at least one rotation detecting brush have shapes configured to provide resilient tension against the commutator.

18. The apparatus according to claim 17, wherein a first of at least one of the electrode brushes and the at least one rotation detecting brush has an L shape configuration and a second of at least one of the electrode brushes and the at least one rotation detecting brush has an U shape configuration.

19. The apparatus according to claim 18, wherein the L shape configuration contacts the commutator with along an extended side of the L shape configuration.

20. The apparatus according to claim 18, wherein the U shape configuration contacts the commutator on a straight length offset portion of the U shape configuration.

21. The apparatus according to claim 15, wherein said direct current motor further comprises:
a first brush-contact-preventing wall provided in the support base is configured to prevent the at least one rotation detecting brush from being proximate to at least one of the electrode brushes; and
a second brush-contact-preventing wall provided in the support base is configured to prevent the at least one of the electrode brushes from being proximate to the at least one rotation detecting brush.

22. The apparatus according to claim 14, wherein said direct current motor further comprises:
a rotation detecting device connected to the at least one rotation detecting brush and configured to detect the signal on the commutator.

23. The apparatus according to claim 22, wherein said at least one rotation detecting device is configured to detect at least one of a rotational speed, a cumulative rotation number, and a rotational direction of the direct current motor.

24. The apparatus according to claim 23, wherein the rotation detecting device comprises:
a noise removing circuit configured to remove high frequency noise components from the signal on the commutator;
a reference voltage generating device configured to convert the signal on the commutator and to output a converted voltage; and
a comparator configured to compare the converted voltage to a reference voltage and output a first level voltage when the converted voltage is at least the reference voltage and output a second level voltage different from said first level voltage when the converted voltage is less than the reference voltage, output from said comparator having a peak height and peak width.

25. The apparatus according to claim 24, wherein the peak width of the said output from said comparator varies in accordance with the rotation speed of the direct current motor.

26. The apparatus according to claim 14, wherein the pair of electrode brushes is configured to contact the commutator at representative first and second rotation angle positions 180° apart on the commutator and the at least one rotation detecting brush is configured to contact the commutator at a third rotation angle position such that an angle formed between the at least one rotation detecting brush and one of the electrode brushes is less than 180°/n, where n is the number of rotor magnetic poles.

27. A direct current motor comprising:
a stator;
a rotor including,
a rotation shaft, and rotor coils;
a commutator integrally provided with the stator and connected to the rotor coils;
means for supplying electric power from the commutator to the rotor coils;
means for changing a state of a direct current drive voltage to the rotor coils; and
means for detecting a signal on the commutator indicative of an operation of the direct current motor,
wherein the means for detecting a signal detects the signal on the commutator from a different axial position on the commutator than the means for supplying electric supplies power to the commutator.

28. The direct current motor according to claim 27, further comprising:
a first means for connecting externally to the means for supplying electric power;
a second means for connecting externally to the means for detecting a signal; and
means for rotatably holding the rotation shaft of the rotor,
wherein said first and second means are fixed on said means for rotatably holding.

29. The direct current motor according to claim 28, further comprising:
means for preventing contact between the means for supplying electric power and the means for detecting a signal with the commutator during assembly of the commutator onto the means for rotatably holding.

30. The direct current motor according to claim 29, wherein the means for supplying electric power and the means for detecting a signal provide resilient tension against the commutator.

31. The direct current motor according to claim 28, further comprising:
means for preventing contact between the means for supplying electric power and the means for detecting a signal.

32. The direct current motor according to claim 27, further comprising:
means for detecting rotation of the commutator.

33. The direct current motor according to claim 32, wherein said means for detecting rotation detects at least one of a rotational speed, a cumulative rotation number, and a rotational direction of the direct current motor.

34. The direct current motor according to claim 33, wherein the means for detecting rotation comprises:
means for removing high frequency noise components from the signal on the commutator;
means for converting the signal on the commutator; and
means for outputting a converted voltage;
means for comparing the converted voltage to a reference voltage and outputting a first level voltage when the converted voltage is at least the reference voltage and outputting a second level voltage different from said first level voltage when the converted voltage is less than the reference voltage, output from said means for comparing has a peak height and peak width.

35. The direct current motor according to claim 34, wherein the peak width of the said output from said means for comparing varies in accordance with the rotation speed of the direct current motor.

36. The direct current motor according to claim 27, wherein the means for supplying electric power contact the commutator at representative first and second rotation angle positions 180° apart on the commutator and the means for detecting a signal contact the commutator at a third rotation angle position such that an angle formed between the means for detecting a signal and the means for supplying electric power is less than 180°/n, where n is the number of rotor magnetic poles.

37. A method of assembling a direct current motor with a stator, a rotor including a rotation shaft and rotor coils, a commutator, a pair of electrode brushes and at least one rotation detecting brush in sliding contact with the commutator, comprising the steps of:
forming the electrode brushes and the at least one rotation detection brush in predetermined shapes configured to provide resilient tension against the commutator;
fixing the electrode brushes and the at least one rotation detection brush on a support base of the rotor;
inserting a jig through holes in the support base;
displacing with the jig the electrode brushes and the at least one rotation detection brush to a position on the support base which is outside an outer diameter of the commutator;
assembling the commutator and rotation shaft onto the support base; and
removing the jig and thereby contacting the electrode brushes and the at least one rotation detection brush on the commutator.
